(19) United States
(12) Patent Application Publication
(10) Pub. No.: US 2016/0107496 A1
(43) Pub. Date: Apr. 21, 2016

(54) AIR SPRING

(71) Applicant: CONTINENTAL TEVES AG & CO. OHG, Frankfurt (DE)

(72) Inventor: Ralf Pielock, Essel (DE)

(73) Assignee: Continental Teves AG & Co. oHG, Frankfurt (DE)

(21) Appl. No.: 14/896,425

(22) PCT Filed: May 23, 2014
(86) PCT No.: PCT/EP2014/060676

§ 371 Date: Dec. 7, 2015

(30) Foreign Application Priority Data
Jun. 20, 2013 (DE) 10 2013 211 666.7

(51) Int. Cl. B60G 11/27; F16F 9/04; F16F 9/05

(52) U.S. Cl. CPC B60G 11/27; F16F 9/05; F16F 9/0409; F16F 9/0445; B60G 2202/152

(57) ABSTRACT

An air spring for vehicles, having an air spring bellows clamped in an air-tight manner between an air spring cover and an air spring rolling piston. The air spring bellows is made of a composite material consisting of an elastomer material having on or more embedded reinforcing layers, which bellows, along with the air spring cover and the air spring rolling piston, delimits a working chamber filed with compressed air and, by forming a rolling fold, rolls over the air spring rolling piston. The air spring bellows includes a first air spring bellows section and a second air spring bellows section joined together in an overlap region and having reinforcing layers running at a different angle to a longitudinal axis L of the air spring. The first and second air spring bellows sections are separated by a freely movable clamp joint arranged in the overlap region.

### CROSS REFERENCE TO RELATED APPLICATIONS

This application is the US National Phase Application of PCT International Application No. PCT/EP2014/060676, filed May 23, 2014, which claims the priority to German Patent Application No. 10 2013 211 666.7, filed Jun. 20, 2013, the contents of such applications being incorporated by reference herein.

### FIELD OF THE INVENTION

The invention relates to an air spring for vehicles, having an air spring bellows, which is made from a composite material composed of an elastomer material with one or more embedded reinforcing layers and clamped in an air-tight manner between an air spring cover and an air spring rolling piston, which bellows together with the air spring cover and the air spring rolling piston defines a working chamber filled with compressed air and which in forming a rolling fold rolls on the air spring rolling piston, wherein the air spring bellows comprises a first air spring bellows portion and a second air spring bellows portion, which are connected to one another in an overlap area and comprise reinforcing layers running at a different angle to an air spring longitudinal axis.

### BACKGROUND OF THE INVENTION

Air springs, which are clamped between the chassis and the vehicle body and which comprise an air spring bellows, which in turn is fixed between an air spring cover and a rolling piston, are known in a number of designs. In operation the air spring is under an internal pressure. The air spring bellows rolls under load and during spring movements rolls on the external contour of the concentric air spring piston, forming a rolling fold. Such an air spring is often used in road or rail vehicles in order to achieve a comfortable suspension.

In air springs for automobiles the air spring bellows used are as thin-walled as possible, since these ensure a high degree of ride comfort. In order to achieve sufficient load-bearing capacity of the overall system in these bellows, the air spring bellows and/or the air springs or dampers are provided with so-called outer guides, that is to say with a tubular sleeve enclosing the air spring bellows as a “support corset” or supporting element. Thus a thin air spring bellows having a thin light-alloy sleeve as supporting element, for example, can be optimized for high internal pressures and therefore high load-bearing capacities at the same time as a good harshness behavior.

Owing to the often limited space available, it may be necessary to use an air spring without an outer guide. In the case of these so-called uncovered or free-standing air springs, kinematic axial movements and inherent torsion of the bellows give rise to torsional movements between the air spring cover and the air spring rolling piston. If the air spring bellows is provided as a cross-ply bellows, the bellows is capable of absorbing a torsion with small torsion angles. With large torsion angles, on the other hand, there is the risk of the reinforcing layers being damaged.

In order to counter this risk, torsion bearings in the form of slide bearings are provided, for example. DE 10 2005 045 804 A1, which is incorporated by reference also discloses an air spring in an overhead position, in which the air spring bellows is supported on a supporting ring, which is supported on the air spring cover by way of a rolling-contact bearing.

The known approaches to a solution have the disadvantage, however, that as a rule additional overall axial space is needed and that adapted joining techniques make the design of the air spring more complicated and thereby also more cost-intensive.

DE 10 2012 201 104 A1, which is incorporated by reference furthermore discloses an air spring bellows comprising two air spring bellows portions, wherein an upper air spring bellows portion is formed in such a way that it is capable of absorbing torsional movements. According to DE 10 2012 201 104 A1, the lower air spring bellows portion, which primarily fulfils comfort requirements, rolls on the outside of the rolling piston on the one hand and on the inside of an outer guide, fixed to the air spring bellows, on the other, so that the two functional areas are separated by the outer guide.

### SUMMARY OF THE INVENTION

An aspect of the invention, therefore, provides an air spring for vehicles, which on the one hand satisfies the comfort requirements without affecting the overall axial extent, and on the other allows greater torsional movements without causing damage.

According to an aspect of the invention the first and the second air spring bellows portion provided are separated by a freely movable clamped joint arranged in the overlap area. The separation of the functional areas represented by the two air spring bellows portions can thereby also be achieved in an uncovered air spring without the need for further torsion-absorbing components. This furthermore allows free scope in designing the air spring components—in particular the air spring cover.

According to an advantageous embodiment of the invention a support ring, which is arranged on an inside of the air spring bellows and which is positioned by means of a clamping ring of the air spring bellows, is provided as clamped joint. Simple and inexpensive components can therefore be used to produce the clamped joint.

The first air spring bellows portion is preferably formed as a torsionally flexible fold, thereby enabling the first air spring bellows portion to absorb not only torsional forces but also Cardanic movements.

According to a further advantageous development of the invention a premature buckling of the air spring can be prevented by providing the support ring with radial guidance in the form of an axial extension of the air spring cover.

The first air spring bellows portion is preferably provided as an axial bellows having reinforcing layers parallel or virtually parallel to the air spring longitudinal axis, and the second air spring bellows portion as a cross-ply bellows having reinforcements running at an angle to the air spring longitudinal axis. Also possible, however, is an alternative embodiment in which the first air spring bellows portion is provided as a cross-ply bellows having reinforcements running at a first angle to the air spring longitudinal axis, and the second air spring bellows portion as a cross-ply bellows having reinforcements running at a second angle to the air spring longitudinal axis. The air spring bellows can therefore be divided into an elasticity area and a rolling area, wherein the first air spring bellows portion is formed in such a way that it reduces the torsional rigidity of the air spring, and the second air spring bellows portion is suited to the comfort requirements.

### BRIEF DESCRIPTION OF THE DRAWINGS

Further features, advantages and possible applications of the invention are set forth in the dependent claims and the following description of exemplary embodiments and with reference in the drawings, of which, in heavily diagrammatic form and in section:

FIG. 1 shows a first exemplary embodiment of an air spring according to the invention and

FIG. 2 shows a second exemplary embodiment of an air spring according to the invention.

### DETAILED DESCRIPTION OF THE PREFERRED EMBODIMENTS

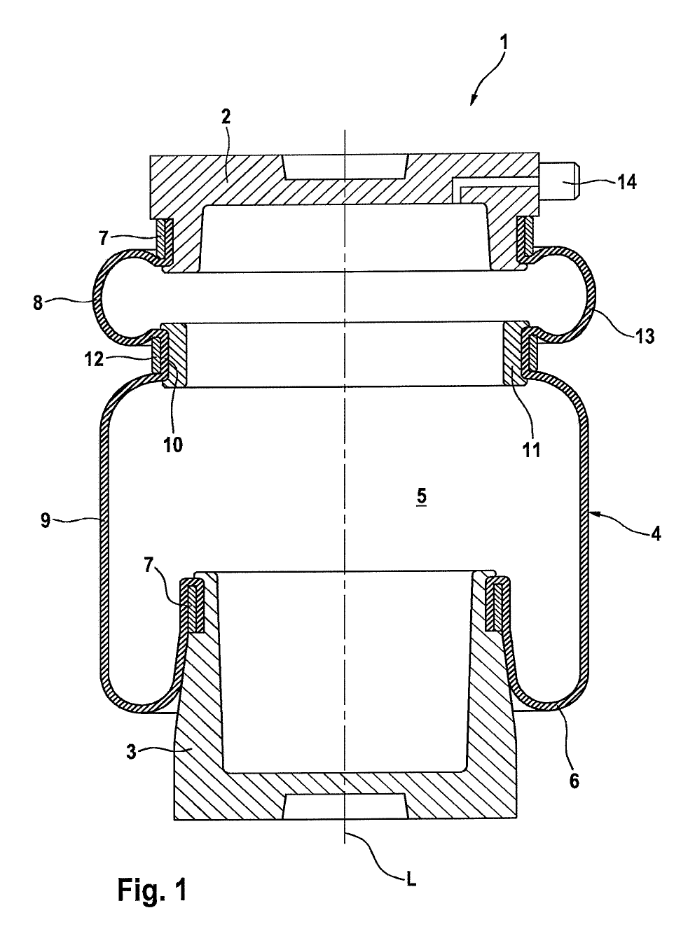

FIG. 1 in a diagrammatic representation and in section shows a first exemplary embodiment of an air spring 1, which together with an air spring rolling piston 3 and an air spring cover 2 is clamped between the chassis and the vehicle body of a motor vehicle.

The air spring 1 comprises an air spring bellows 4, which is made from a composite material composed of an elastomer material with one or more embedded reinforcing layers and clamped in a sealed manner to an air spring cover 2 and an air spring rolling piston 3, which bellows together with the air spring cover 2 and the air spring rolling piston 3 defines a working chamber 5 filled with compressed air and in forming a rolling fold 6 rolls on the air spring rolling piston 3.

As can be seen from the figure, end areas of the air spring bellows 4 are fixed by means of clamping rings 7 to clamping portions of the air spring cover 2 and the air spring rolling piston 3.

The air spring bellows 4 comprises a first air spring bellows portion 8 and a second air spring bellows portion 9, which are connected to one another by vulcanization in an overlap area 10. In order to allow the two air spring bellows portions to perform different functions, the reinforcing layers of the two air spring bellows portions 8,9 run at a different angle to an air spring longitudinal axis L.

Thus, for example, the first air spring bellows portion 8 is preferably formed as an axial bellows having reinforcing layers parallel or virtually parallel to the air spring longitudinal axis L, thereby forming an elastic, torsionally flexible functional area, which in particular is capable of absorbing torsional movements.

The second air spring bellows portion 9 is provided as a cross-ply bellows having reinforcements running at an angle to the air spring longitudinal axis L and thereby forms a torsionally rigid rolling area suited to the comfort requirements.

According to an alternative embodiment the first air spring bellows portion 8 is provided as a cross-ply bellows, wherein the angles of the reinforcements need to be adapted accordingly, in order to obtain the desired elasticity.

As can be seen from FIG. 1, the two air spring bellows portions 8,9 are separated by a freely movable clamped joint arranged in the overlap area 10.

A freely movable support ring 11, which is arranged on an inside of the air spring bellows 4 and which is positioned by means of a clamping ring 12 of the air spring bellows 4, is provided as clamped joint. The separation of the functional areas represented by the two air spring bellows portions 8,9 can thereby be achieved simply and inexpensively also in an uncovered air spring, without being forced to accept the disadvantages of a larger overall axial extent.

The compressed air passes into the working chamber 5 through an air connection 14 arranged on the air spring cover 2, producing a defined internal excess pressure.

The second air spring bellows portion 9 embodied as a cross-ply bellows here attains a desired diameter due to the crossing of the reinforcements.

Under internal pressure, the first air spring bellows portion 8, which as described above may be provided as an axial or cross-ply bellows, produces a torsionally flexible fold 13, according to the angles of the reinforcements and the matching of the effective rolling fold diameter to the center of the torsional fold curvature, so that the first air spring bellows portion 8 is capable of absorbing not only torsional forces but also Cardanic movements.

The axial position of the inner support ring 11 is attained in the state of equilibrium between the two air spring bellows portions 8,9 and is decisively determined by the extent of the upper fold 13, the diameter of the fold 13 being determined by the upper bellows area length and the angle of the reinforcements.

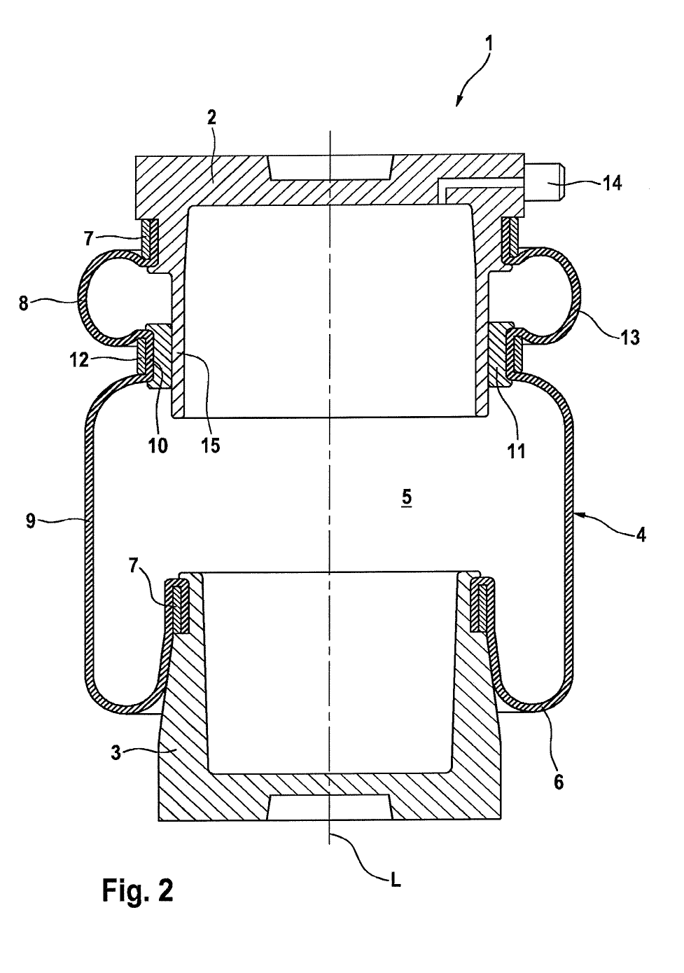

FIG. 2 shows a second exemplary embodiment. This differs only in that the air spring cover 2 comprises an axial, circumferential extension 15, which serves to guide the support ring 11 radially. A premature buckling of the air spring 1 can thereby be prevented.

### REFERENCE SIGNS

1 air spring
2 air spring cover
3 air spring rolling piston
4 air spring bellows
5 working chamber
6 rolling fold
7 clamping ring
8 air spring bellows portion
9 air spring bellows portion
10 overlap area
11 support ring
12 clamping ring
13 fold
14 air connection
15 extension

L air spring longitudinal axis

1. An air spring for vehicles, having an air spring bellows, which is made from a composite material composed of an elastomer material with one or more embedded reinforcing layers and clamped in an air-tight manner between an air spring cover and an air spring rolling piston, which bellows together with the air spring cover and the air spring rolling piston defines a working chamber filled with compressed air and which in forming a rolling fold rolls on the air spring rolling piston, wherein the air spring bellows comprises a first air spring bellows portion and a second air spring bellows portion, which are connected to one another in an overlap area and comprise reinforcing layers running at a different angle to an air spring longitudinal axis, and wherein the first and the second air spring bellows portion are separated by a freely movable clamped joint arranged in the overlap area.

2. The air spring as claimed in claim 1, wherein a support ring, which is arranged on an inside of the air spring bellows and which is positioned by a clamping ring of the air spring bellows is provided as a clamped joint.

3. The air spring as claimed in claim 2, wherein the first air spring bellows portion is formed as a torsionally flexible fold.

4. The air spring as claimed in claim 2, wherein the support ring is provided with radial guidance in the form of an axial extension of the air spring cover.

5. The air spring as claimed in claim 1, wherein the first air spring bellows portion is provided as an axial bellows having reinforcing layers parallel or virtually parallel to the air spring longitudinal axis and the second air spring bellows portion as a cross-ply bellows having reinforcements running at an angle to the air spring longitudinal axis.

6. The air spring as claimed in claim 1 the first air spring bellows portion is provided as a cross-ply bellows having reinforcements running at a first angle to the air spring longitudinal axis and the second air spring bellows portion as a cross-ply bellows having reinforcements running at a second angle to the air spring longitudinal axis.

7. The air spring as claimed in claim 3, wherein the support ring is provided with radial guidance in the form of an axial extension of the air spring cover.
